(19) United States
(12) Patent Application Publication
(10) Pub. No.: US 2018/0069446 A1
(43) Pub. Date: Mar. 8, 2018

(54) ROTATING ELECTRICAL MACHINE

(71) Applicant: MITSUBISHI ELECTRIC CORPORATION, Chiyoda-ku, Tokyo (JP)

(72) Inventors: Tatsuro HINO, Chiyoda-ku, Tokyo (JP); Kohei EGASHIRA, Chiyoda-ku, Tokyo (JP); Atsushi SAKAUE, Chiyoda-ku, Tokyo (JP); Tetsuya YOKOGAWA, Chiyoda-ku, Tokyo (JP); Akira HASHIMOTO, Chiyoda-ku, Tokyo (JP); Masashi NAKAMURA, Chiyoda-ku, Tokyo (JP); Hiroyuki AKITA, Chiyoda-ku, Tokyo (JP)

(73) Assignee: MITSUBISHI ELECTRIC CORPORATION, Chiyoda-ku, Tokyo (JP)

(21) Appl. No.: 15/559,806

(22) PCT Filed: Mar. 18, 2016
(86) PCT No.: PCT/JP2016/058720

§ 371 Date: Sep. 19, 2017

(30) Foreign Application Priority Data
Mar. 24, 2015 (JP) 2015-060472

(51) Int. Cl. H02K 3/28; H02K 1/16; H02K 3/12

(52) U.S. Cl. CPC H02K 3/28; H02K 1/276; H02K 3/12; H02K 1/16

(57) ABSTRACT

X1>X2 and X3<X4 are satisfied when a distance in a radial direction at an axial end portion of the armature core between two slot-housed portions adjacent to each other and connected to two slot lead-out portions bent along a circumferential direction in the same direction is denoted by X1, a distance in the radial direction between the slot lead-out portions is denoted by X2, a distance in the radial direction at the axial end portion of the armature core between two slot-housed portions adjacent to each other and connected to two slot lead-out portions bent along the circumferential direction in directions opposite to each other is denoted by X3, and a distance in the radial direction between the two slot lead-out portions bent along the circumferential direction in the directions opposite to each other is denoted by X4.

### TECHNICAL FIELD

The present invention relates to a rotating electrical machine. Particularly, the present invention relates to the structure of an armature winding of a rotating electrical machine.

### BACKGROUND ART

Conventionally, a technique to ensure the insulation property of a coil forming an armature winding which projects from slots of an armature core of a stator of a rotating electrical machine, has been disclosed (see, for example, Patent Document 1 described below).

Patent Document 1 discloses a structure in which end portions, projecting from a slot, of two coils adjacent to each other in a radial direction are bent along a circumferential direction in the same direction (hereinafter, referred to as former structure), and a structure in which end portions, projecting from a slot, of two coils adjacent to each other in the radial direction are bent along the circumferential direction in directions opposite to each other (hereinafter, referred to as latter structure).

### CITATION LIST

### Patent Document

Patent Document 1: Japanese Patent No. 4186872

### SUMMARY OF THE INVENTION

### Problems to be Solved by the Invention

In the case where, for example, four coils are disposed in the radial direction, in the former structure, the end portions of two coils adjacent to each other in the radial direction belong to the same phase among three-phase voltages and have the same potential. Thus, provision of insulating paper between the end portions of the two coils can be omitted. Similarly, the end portions of the remaining two coils adjacent to each other in the radial direction belong to the same phase among the three-phase voltages and have the same potential. Thus, provision of insulating paper between the end portions of the remaining two coils can be omitted. Therefore, insulating paper is needed between the end portions of coils that belong to different phases and are in contact with each other, and the number of sheets of insulating paper which provides insulation in the radial direction can be reduced from three to one. Accordingly, an effect is achieved that the size of a coil end can be reduced and simple production is possible.

It is generally known that in the case where a plurality of coils each having a rectangular cross-section are disposed within a slot so as to be stacked in the radial direction, when the end portions of the coils which project from the slot are bent along the circumferential direction, bulge portions occur in the radial direction at the bending inner side with respect to a bending neutral axis, and thinned portions occur in the radial direction at the bending outer side with respect to the bending neutral axis.

Therefore, as in the former structure, when end portions, projecting from a slot, of two coils adjacent to each other in the radial direction are bent along the circumferential direction in the same direction, bulge portions of the two coils butt against and interfere with each other, so that the end portions of the coils cannot be bent sufficiently. For avoiding such interference between the bulge portions, the necessity arises to ensure in advance a gap for allowing bulge portions to occur in the radial direction in advance. As a result, there is a problem that the space factor of the coils decreases and further the output of the rotating electrical machine decreases.

Meanwhile, in the latter structure, since the end portions of the coils adjacent to each other in the radial direction are bent in the directions opposite to each other, a state where bulge portions interfere with each other in the radial direction as in the former does not occur, so that the gap between the respective coils can be decreased.

However, the end portions of the respective coils which project from the slot belong to the different phases in the radial direction. Thus, it is necessary to interpose insulating paper between all of the end portions of the respective coils, so that there is a problem that the required number of sheets of the insulating paper increases and the size of a coil end is increased.

The present invention has been made to solve the above-described problems, and an object of the present invention is to obtain a rotating electrical machine which has a small size, high output, and high productivity, and also has excellent insulation property.

### Solution to the Problems

A rotating electrical machine according to the present invention is a rotating electrical machine comprising an armature formed by an armature winding being mounted to an annular armature core, wherein the armature winding has slot-housed portions housed in slots formed in the armature core, and slot lead-out portions projecting outside from the slots and connecting the slot-housed portions in a circumferential direction, and when, at a plurality of the slot-housed portions housed in the same slot so as to be aligned in a radial direction and at the slot lead-out portions connected in the axial direction from the respective slot-housed portions,

a distance in the radial direction at an axial end portion of the armature core between the two slot-housed portions adjacent to each other and connected to the two slot lead-out portions which are bent along the circumferential direction in one direction is denoted by X1,

a distance in the radial direction between the two slot lead-out portions which are bent along the circumferential direction in the one direction is denoted by X2,

a distance in the radial direction at the axial end portion of the armature core between the two slot-housed portions adjacent to each other and connected to the two slot lead-out portion which are bent along the circumferential direction in directions opposite to each other is denoted by X3, and

a distance in the radial direction between the two slot lead-out portions which are bent along the circumferential direction in the directions opposite to each other is denoted by X4,

a relationship of X1 to X4 is set so as to satisfy

X1>X2 and X3<X4.

### Effect of the Invention

In the rotating electrical machine according to the present invention, since the slot lead-out portions which are bent in the same direction from the slot-housed portions adjacent to each other in the radial direction are included, the respective slot lead-out portions which belong to the same phase are in contact with each other. Thus, an insulation distance in the radial direction can be reduced, so that effects are achieved that the size of coil end is reduced and the space factor of a coil is improved.

In addition, since a predetermined gap is provided in the radial direction at the axial end portion of the armature core between the slot-housed portions adjacent to the slot lead-out portions which are bent in the same direction, interference between bulge portions occurring in the radial direction at the inner side of bent portions can be avoided, so that the insulation property can be improved.

Furthermore, since the gap between the slot lead-out portions which are bent in the directions opposite to each other can be increased by decreasing the gap between the slot lead-out portions which are bent in the same direction, a large insulation distance in the radial direction can be ensured therebetween. Thus, effects are achieved that the size of coil end is reduced and the space factor of the coil is improved.

### BRIEF DESCRIPTION OF THE DRAWINGS

FIG. 1 is a front single-sided cross-sectional view showing a rotating electrical machine according to Embodiment 1 of the present invention.

FIG. 2 is a perspective view showing an armature and a rotor forming the rotating electrical machine of Embodiment 1.

FIG. 3 is a perspective view showing the armature forming the rotating electrical machine of the Embodiment 1.

FIG. 4 is a side view of the armature of Embodiment 1.

FIG. 5 is a plan view of the armature of Embodiment 1.

FIG. 6 is a plan view showing an armature core forming the armature of Embodiment 1.

FIG. 7 is a front view showing a set of partial coils forming an armature winding used in the armature of the rotating electrical machine according to Embodiment 1 of the present invention.

FIG. 8 is a plan view of the set of partial coils of Embodiment 1.

FIG. 9 is a perspective view of the set of partial coils of Embodiment 1.

FIG. 10 is a cross-sectional schematic view of a winding state of partial coils with respect to the armature core of the rotating electrical machine according to Embodiment 1 of the present invention, as seen from an axial direction.

FIG. 11 illustrates a processing situation for moving end portions of the partial coil in parallel in a radial direction.

FIG. 12 is a cross-sectional schematic view taken along the line A-A in FIG. 10.

FIG. 13 is a cross-sectional schematic view taken along the line B-B in FIG. 12.

FIG. 14 illustrates a deformation state occurring when the partial coils are bent in a circumferential direction.

FIG. 15 is a cross-sectional schematic view, corresponding to FIG. 12, of an armature used in a conventional rotating electrical machine.

FIG. 16 is a perspective view showing an armature and a rotor in a rotating electrical machine according to Embodiment 2 of the present invention.

FIG. 17 is a perspective view showing a core block of the armature in the rotating electrical machine of Embodiment 2.

FIG. 18 is a front view of a partial coil forming an armature winding used in the armature of the rotating electrical machine according to Embodiment 2 of the present invention.

FIG. 19 is a plan view of the partial coil of Embodiment 2.

FIG. 20 is a perspective view of the partial coil of Embodiment 2.

FIG. 21 is a cross-sectional schematic view of a winding state of partial coils with respect to an armature core of the rotating electrical machine according to Embodiment 2 of the present invention, as seen from an axial direction.

FIG. 22 is a cross-sectional schematic view taken along the line C-C in FIG. 21.

FIG. 23 is a cross-sectional schematic view taken along the line D-D in FIG. 22.

FIG. 24 is a cross-sectional schematic view taken along the line E-E in FIG. 22.

### DESCRIPTION OF EMBODIMENTS

### Embodiment 1

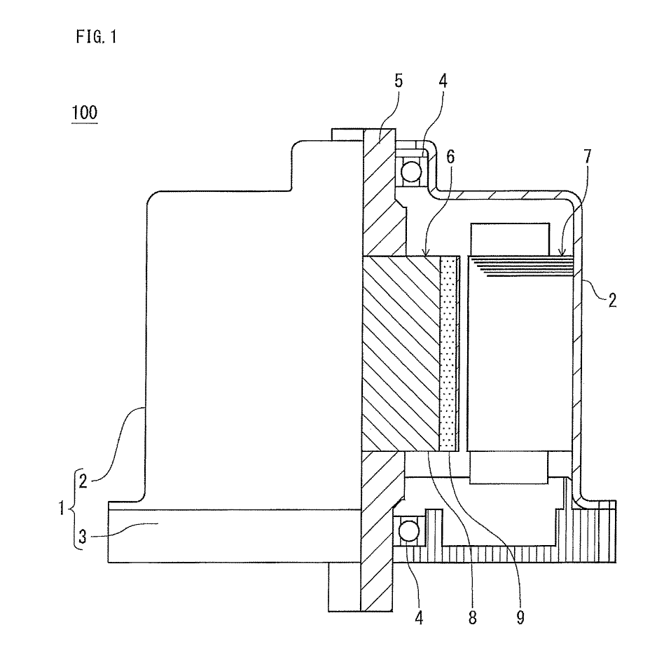

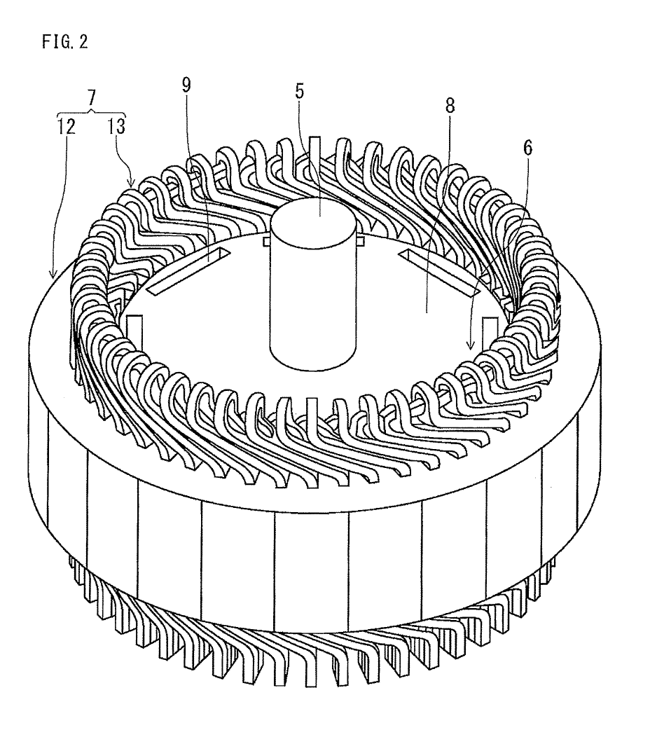

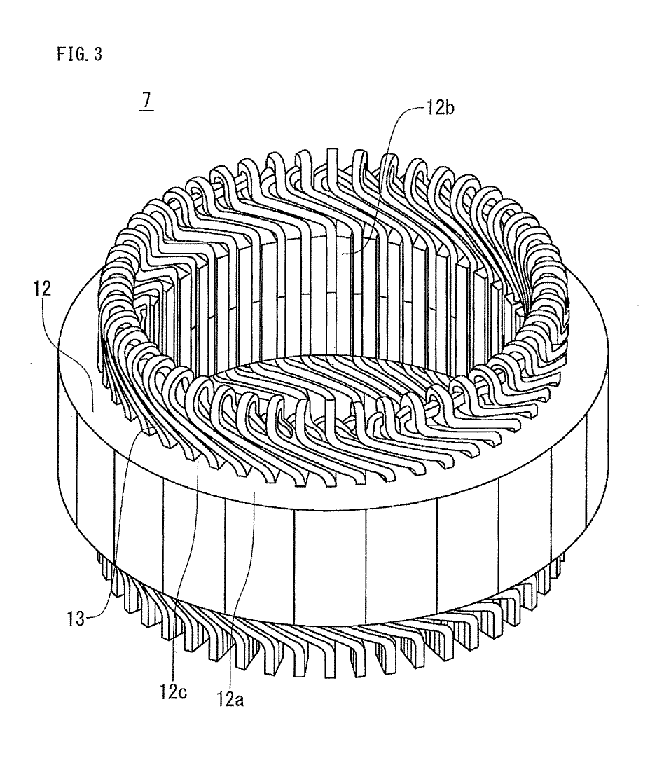

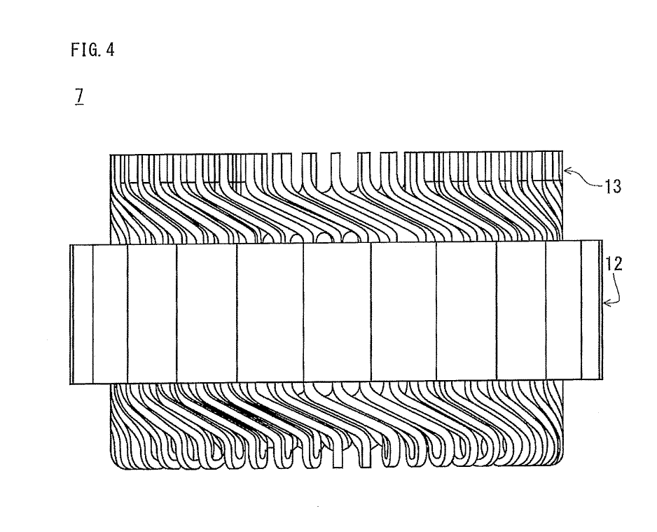

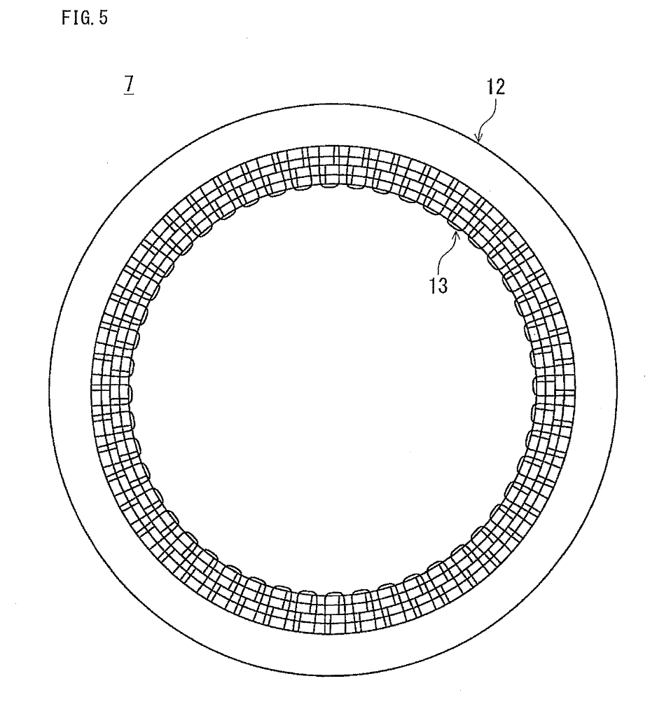

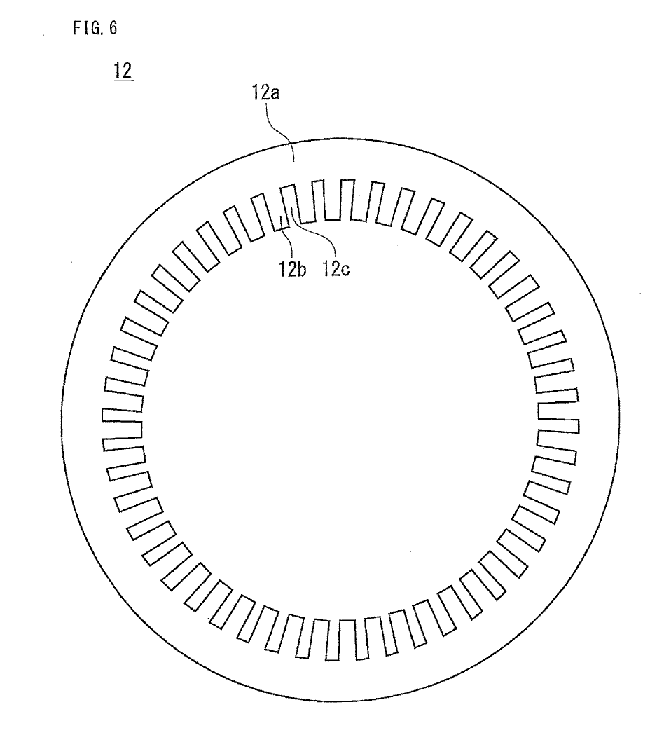

FIG. 1 is a front single-sided cross-sectional view showing a rotating electrical machine according to Embodiment 1 of the present invention, FIG. 2 is a perspective view showing an armature and a rotor forming the rotating electrical machine of Embodiment 1, and FIG. 3 is a perspective view showing the armature forming the rotating electrical machine of Embodiment 1. In addition, FIG. 4 is a side view of the armature of Embodiment 1, FIG. 5 is a plan view of the armature of Embodiment 1, and FIG. 6 is a plan view showing an armature core forming the armature of Embodiment 1.

A rotating electrical machine 100 according to Embodiment 1 includes a housing 1, and the housing 1 includes: a substantially cylindrical frame 2 having an upper end portion which is reduced in diameter, and a lower end portion which is enlarged in diameter; and an end plate 3 which closes the opening of the lower end portion of the frame 2 which is enlarged in diameter. Bearings 4 are respectively provided at the end plate 3 and the upper end portion of the frame 2 which is reduced in diameter, a rotary shaft 5 is rotatably supported via the shown upper and lower bearings 4, and a rotor 6 is mounted on the rotary shaft 5. In addition, an armature 7 is fixed to an inner wall of the frame 2 at a location corresponding to the rotor 6, with a predetermined gap between the armature 7 and the rotor 6.

The rotor 6 is a permanent magnet type rotor, and includes: a rotor core 8 which is fixed to the rotary shaft 5 which is inserted at the axial position; and permanent magnets 9 which are embedded at the outer peripheral surface side of the rotor core 8 and arranged at a predetermined pitch along the circumferential direction of the rotor core 8, to form magnetic poles. The rotor 6 is not limited to such a permanent magnet type rotor, and a squirrel-cage rotor in which a non-insulated rotor conductor is housed in a slot of the rotor core 8 and both sides thereof are short-circuited by a short-circuit ring, or a wound rotor in which an insulated conductor wire is mounted in a slot of the rotor core 8, may be used.

The armature 7 includes: an armature core 12 and an armature winding 13 mounted to the armature core 12. The armature core 12 is produced by stacking and integrating a predetermined number of electromagnetic steel sheets in the axial direction, and includes: a cylindrical core back portion 12a; teeth 12b which are provided so as to extend inward in the radial direction from an inner peripheral wall surface of the core back portion 12a; and slots 12c formed by the teeth 12b. In this case, the respective teeth 12b and the respective slots 12c are arranged at equal intervals in the circumferential direction. Each of the teeth 12b is formed in a tapered shape in which the width in the circumferential direction gradually narrows inward in the radial direction, and therefore each of the slots 12c is open at the radially inner side and has a rectangular shape in a plan view from the axial direction.

Here, when, for convenience of explanation, it is assumed that the number of the poles is eight, the number of the slots 12c of the armature core 12 is 48, and the armature winding 13 is a three-phase winding, two slots 12c are formed per pole per phase in the armature core 12.

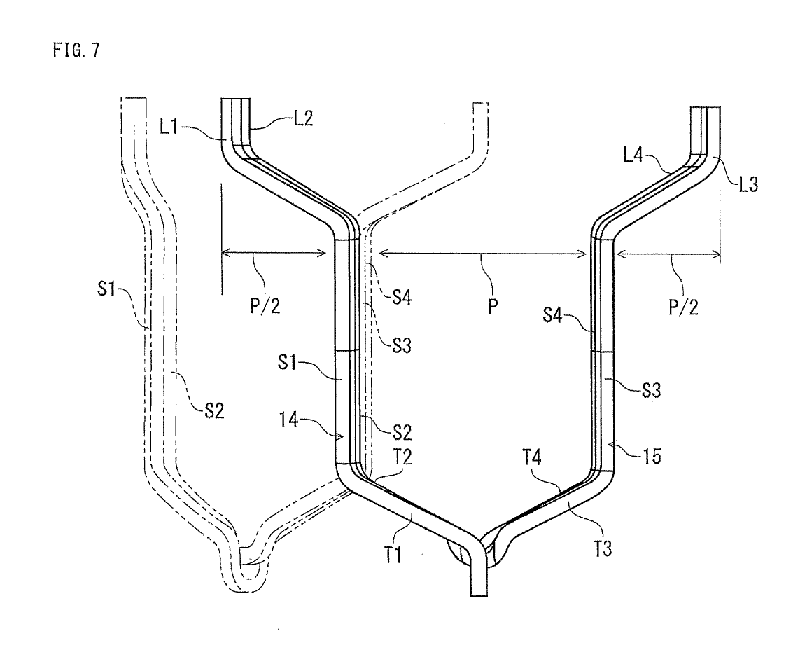

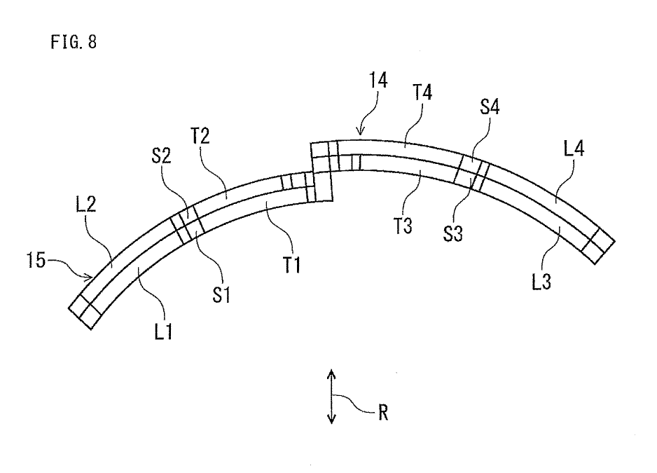

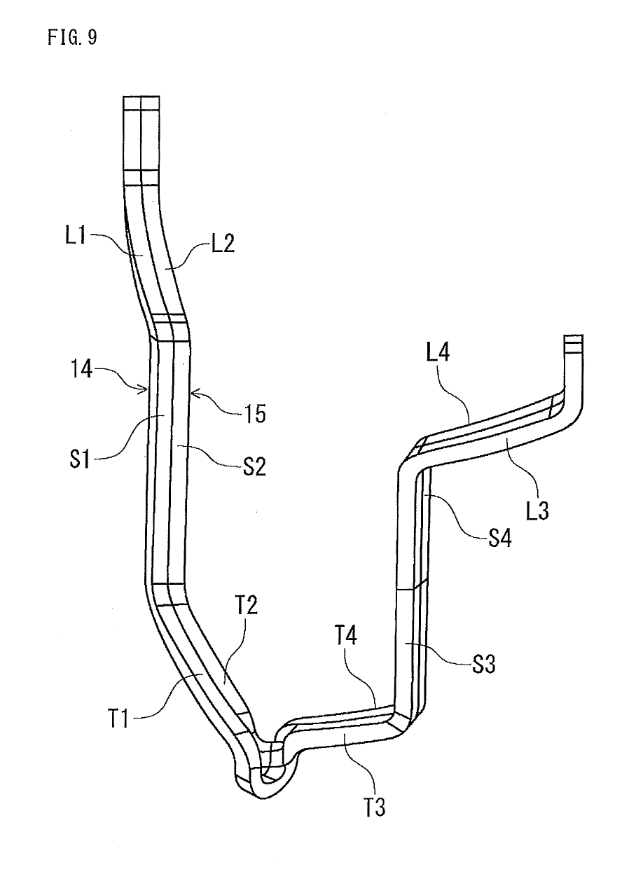

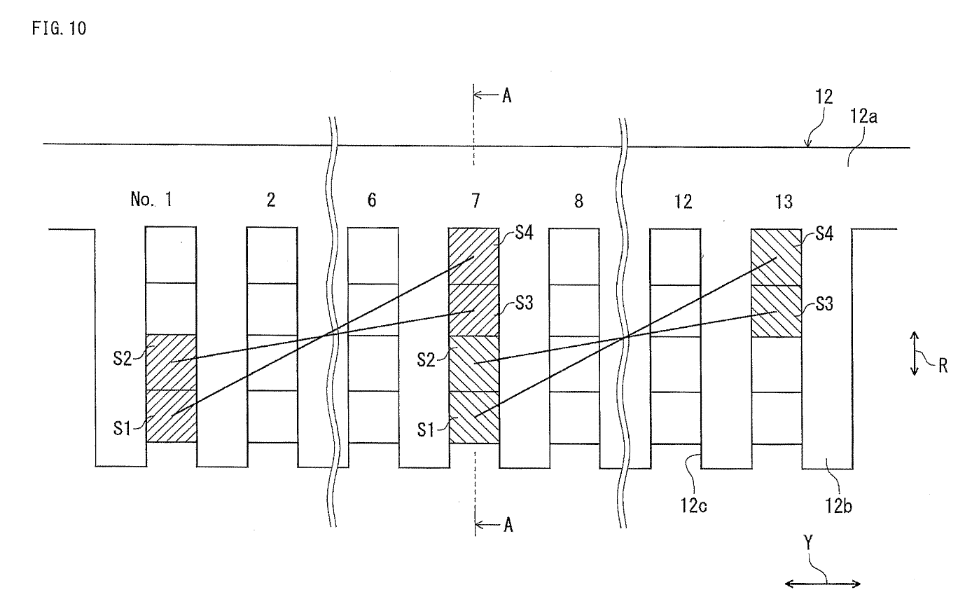

FIG. 7 is a front view showing one set of partial coils forming the armature winding, FIG. 8 is a plan view of the set of partial coils in FIG. 7, and FIG. 9 is a perspective view of the set of partial coils in FIG. 7. In addition, FIG. 10 is a cross-sectional schematic view of a winding state of partial coils with respect to the armature core, as seen from the axial direction. In FIG. 7, another set of partial coils adjacent to the one set of partial coils at one side in the circumferential direction are shown by alternate long and two short dashes lines.

In Embodiment 1, the armature winding 13 has two types of partial coils 14 and 15. These partial coils 14 and 15 are made as one set, and half of one phase of the armature winding 13 is formed by continuously connecting sets of partial coils 14 and 15 for one turn in the circumferential direction of the armature core 12. As each of the partial coils 14 and 15, a conductor wire having a rectangular cross-section and composed of, for example, a jointless continuous copper wire or aluminum wire that is coated with an enamel resin so as to be insulated, is used.

Here, the one partial coil 14 has: two slot-housed portions S1 and S4 which each have a straight rod shape and are housed in the slots 12c of the armature core 12; jointless continuous turn portions T1 and T4 which integrally connect the slot-housed portions S1 and S4; and two leg portions L1 and L4 which individually project from the slot-housed portions S1 and S4 and are bent along the circumferential direction in directions opposite to each other.

Similarly, the other partial coil 15 has: two slot-housed portions S2 and S3 which each have a straight rod shape and are housed in the slots 12c of the armature core 12; jointless continuous turn portions T2 and T3 which integrally connect the slot-housed portions S2 and S3; and two leg portions L2 and L3 which individually project from the slot-housed portions S2 and S3 and are bent along the circumferential direction in directions opposite to each other.

In this case, however, each of a pair of the leg portions L1 and L2 adjacent to each other and a pair of the leg portions L3 and L4 adjacent to each other, of the respective partial coils 14 and 15 are bent along the circumferential direction in the same direction.

Hereinafter, the turn portions T1 to T4 and the leg portions L1 to L4 are collectively referred to as slot lead-out portion.

The interval between a pair of the slot-housed portions S1 and S4 of the partial coil 14 and the interval between a pair of the slot-housed portions S2 and S3 of the other partial coil 15 are set such that the slot-housed portions S1 and S4 and the slot-housed portions S2 and S3 are separated from each other by the distance corresponding to six slots in the circumferential direction. The six slots in this case are the interval between the centers of the slots 12c that are separated from each other by the distance corresponding to continuous six teeth 12b, and correspond to one magnetic pole pitch P.

In addition, terminal end portions of the leg portions L1 and L2 of the respective partial coils 14 and 15 are separated from the respective slot-housed portions S1 and S2 by the distance corresponding to a half magnetic pole pitch (=P/2). Similarly, terminal end portions of the other leg portions L4 and L3 of the respective partial coils 14 and 15 are separated from the respective slot-housed portions S4 and S3 by the distance corresponding to the half magnetic pole pitch (=P/2).

Therefore, as shown in FIG. 10, for example, when consecutive numbers are individually assigned to the respective slots 12c, which are formed so as to be aligned in a circumferential direction Y, in order from left to right in the drawing, if the slot-housed portions S1 and S2 are housed in the seventh slot 12c, the slot-housed portions S3 and S4 are housed in the thirteenth slot 12c which is separated from the seventh slot 12c by the distance corresponding to six slots. In addition, when focusing on another set of the partial coils 14 and 15 (shown by alternate long and two short dashes lines at the left side in FIG. 7) adjacent to this set of the partial coils 14 and 15 at one side (e.g., the left side) in the circumferential direction, if the slot-housed portions S1 and S2 of the other set are housed in the first slot 12c, the slot-housed portions S3 and S4 of the other set are housed in the seventh slot 12c which is separated from the first slot 12c by the distance corresponding to six slots.

Therefore, when focusing on only the seventh slot 12c, if the slot-housed portions S1 and S2 of the partial coils 14 and 15 shown by solid lines in FIG. 7 are housed in this slot 12c, the slot-housed portions S3 and S4 of the partial coils 14 and 15 shown by the alternate long and two short dashes lines at the left side of these partial coils 14 and 15 in the circumferential direction are housed in this slot 12c. That is, in the seventh slot 12c, the slot-housed portions S1 to S4 for four layers are housed in a radial direction R of the armature core 12. Also in each of the other slots 12c, similarly, the slot-housed portions S1 to S4 for four layers are housed. Thus, all of the respective partial coils 14 and 15 of which the slot-housed portions S1 to S4 for four layers are housed together in one slot 12c belong to the same phase.

The armature winding 13 is formed by: inserting the slot-housed portions S1 to S4 of the respective partial coils 14 and 15 into the slots 12c of the armature core 12 from the radial direction R, subsequently bending the leg portions L1 to L4 in the circumferential direction Y, and then joining the terminal end portions of the leg portions L1 to L4 by joining means such as welding to form a coil; and connecting a power feeding portion, a neutral point, or the like to the coil.

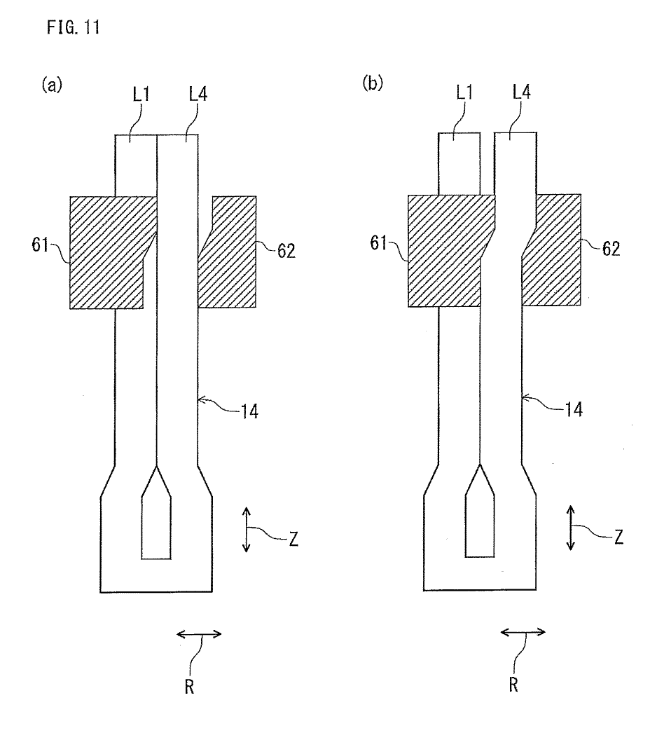

As seen also from FIG. 8, for example, regarding one partial coil 14, the leg portion L4 is desirably moved in parallel in the radial direction R relative to the other leg portion L1 before the respective leg portions L1 and L4 are bent in the circumferential direction Y. Therefore, processing of, for example, holding the leg portion L4 between a pair of left and right molds 61 and 62 as shown in FIG. 11(a) and moving the leg portion L4 in parallel by using both molds 61 and 62 as shown in FIG. 11(b), is executed beforehand.

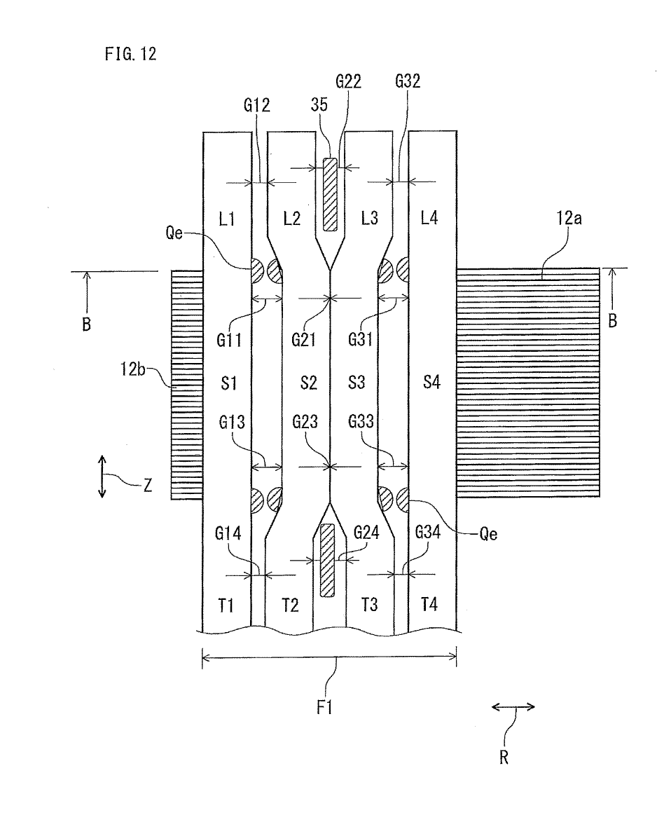

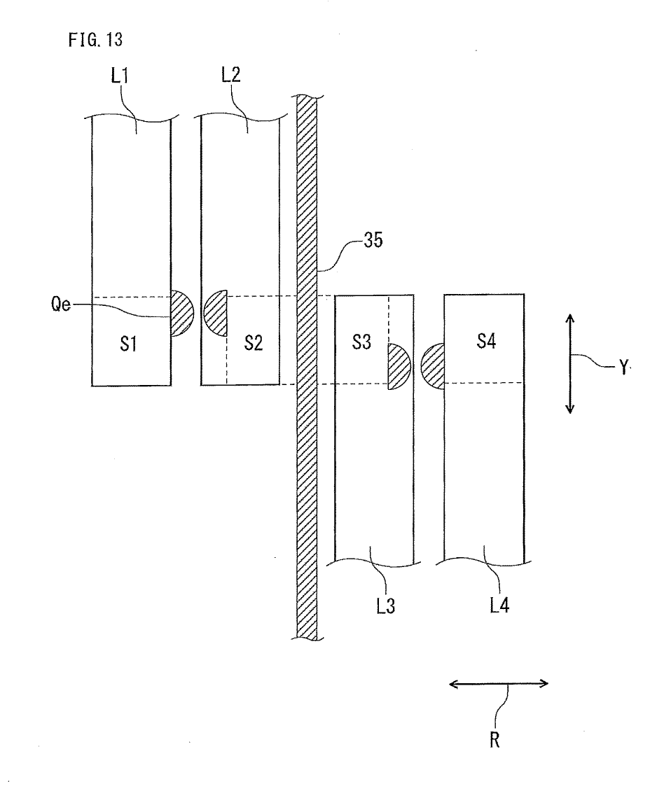

FIG. 12 is a cross-sectional schematic view taken along the line A-A in FIG. 10, and FIG. 13 is a cross-sectional schematic view taken along the line B-B in FIG. 12. In FIG. 12, the right-left direction is the radial direction R, and the up-down direction is an axial direction Z. In addition, in FIG. 13, the right-left direction is the radial direction R, and the up-down direction is the circumferential direction Y.

As described above, when focusing on a certain slot 12c (the seventh slot 12c in this example), the slot-housed portions S1 to S4 for four layers are housed in this slot 12c in the radial direction R of the armature core 12 by one set of the partial coils 14 and 15 and another set of the partial coils 14 and 15 (shown by the alternate long and two short dashes lines in FIG. 7) adjacent thereto at one side in the circumferential direction.

In this case, since the leg portions L1 and L2 adjacent to each other are bent in the same direction, and the other leg portions L3 and L4 adjacent to each other are also bent in the same direction, only an in-phase potential occurs between the leg portions L1 and L2 and between the leg portions L3 and L4. Thus, an insulation distance can be decreased, so that an insulating member such as insulating paper can be omitted, and an effect of improving the productivity is achieved. Similarly, since the turn portions T1 and T2 adjacent to each other are bent in the same direction, and the other turn portions T3 and T4 adjacent to each other are also bent in the same direction, only an in-phase potential occurs therebetween. Thus, an insulation distance can be decreased, so that an insulating member can be omitted, and an effect of improving the productivity is achieved.

Annular insulating members 35 having axes which coincide with the axis of the armature 7 may be provided between the two leg portions L2 and L3 and between the turn portions T2 and T3, respectively. The provision of the insulating members 35 can ensure an insulation distance between the partial coils of different phases in the radial direction, so that an effect of being able to improve the insulation property is achieved.

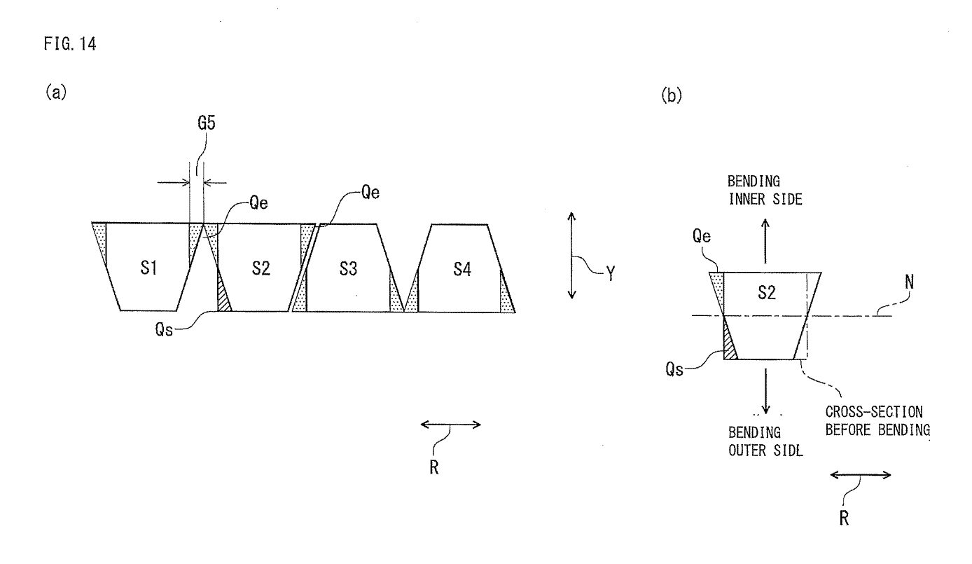

FIG. 14(a) is a diagram illustrating a deformation state occurring at the boundary between the slot-housed portions and the leg portions of the partial coil when the leg portions are bent in the circumferential direction, and FIG. 14(b) is a partially enlarged view corresponding to the slot-housed portion S2 in FIG. 14(a). In FIGS. 14(a) and 14(b), the right-left direction is the radial direction R, and the up-down direction is the circumferential direction Y, which corresponds to FIG. 13.

In bending the partial coils 14 and 15 in the circumferential direction Y, compressive stress acts at the bending inner side, and tensile stress acts at the bending outer side. At this time, bulge portions Qe which bulge in the radial direction R occur at the inner side with respect to a neutral axis N at which bending stress is “0”, and thinned portions Qs which are thinned in the radial direction R occur at the outer side with respect to the neutral axis N.

Here, at upper and lower end portions, projecting from the slot 12c, of the respective slot-housed portions S1 to S4, bulge portions Qe occur between the slot-housed portions S1 and S2 and the slot-housed portion S3 and the slot-housed portion S4, respectively. Thus, for avoiding interference between the bulge portions Qe, it is necessary to provide a certain gap between these slot-housed portions in the radial direction R. Meanwhile, since the leg portions L2 and L3 which project from the slot-housed portion S2 and the slot-housed portion S3 are bent along the circumferential direction Y in the directions opposite to each other, the bulge portions Qe and the thinned portions Qs do not interfere with each other. Therefore, the gap between the slot-housed portion S2 and the slot-housed portion S3 can be decreased.

In the case where the slot-housed portions S1 to S4 for four layers are housed in one slot 12c as shown in FIG. 12, when the gaps between the leg portions L1 to L4 aligned in the radial direction R are denoted by G12, G22, and G32, respectively, the gaps between the turn portions T1 to T4 aligned in the radial direction R are denoted by G14, G24, and G34, respectively, the gaps between the slot-housed portions S1 to S4 at the side connected to the leg portions L1 to L4 are denoted by G11, G21, and G31, respectively, and the gaps between the slot-housed portions S1 to S4 at the side connected to the turn portions T1 to T4 are denoted by G13, G23, and G33, the following dimensional relationships are preferably satisfied for avoiding interference between the bulge portions Qe.

G11≧G12 (1)

G13≧G14 (2)

G21≦G22 (3)

G23≦G24 (4)

G31≧G32 (5)

G33≧G34 (6)

In the case of forming the partial coils 14 and 15 by using molds, actually, the formation is performed more easily with G11≈G31≈G13≈G33, G12≈G32≈G14≈G34, G21≈G23, and G22≈G24, than when the above respective intervals are finely specified. Thus, when: G11, G31, G13, and G33 are set at the same distance X1; G12, G32, G14, and G34 are set at the same distance X2; G21 and G23 are set at the same distance X3; and G22 and G24 are set at the same distance X4, the above relationships (1) to (6) are put together as follows.

X1≧X2 (7)

X3≦X4 (8)

That is, the relationships (7) and (8) are preferably satisfied at the same time for actually avoiding interference between the bulge portions Qe.

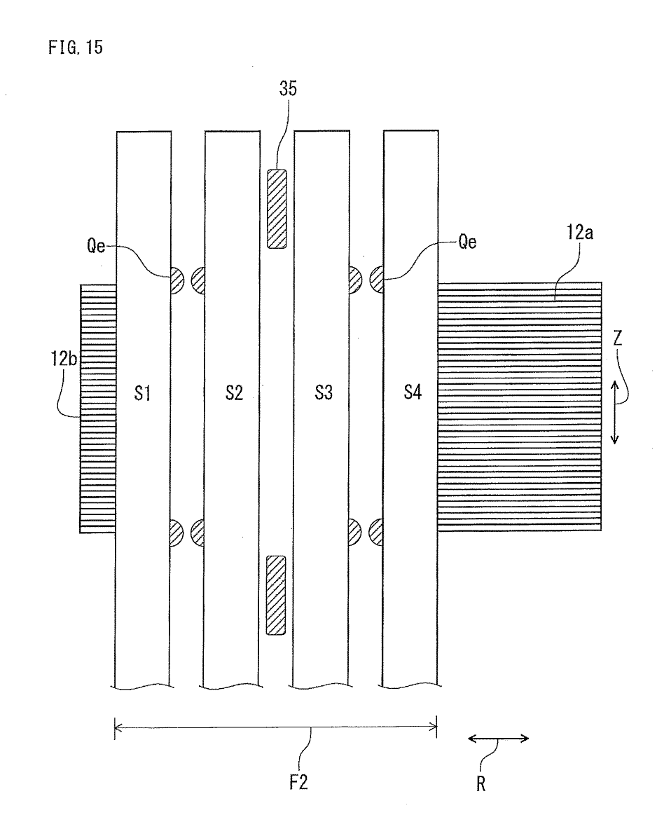

When such dimensional relationships are satisfied, the distance X2 (G11, G31, G13, G33) between the slot lead-out portions which are bent in the same direction can be decreased, and the distance X4 (G22, G24) between the slot lead-out portions which are bent in the directions opposite to each other can be increased. Thus, a large insulation distance in the radial direction can be ensured therebetween. Accordingly, an effect is achieved that a thickness F1 (see FIG. 12), in the radial direction R, of coil end is reduced as compared to a thickness F2, in the radial direction R, of coil end in the case with a structure in which end portions, projecting from a slot, of two partial coils adjacent to each other in the radial direction are bent along the circumferential direction in the same direction in the aforementioned Patent Document 1 as shown in FIG. 15. In addition, an effect is achieved that the space factor of the coil in each slot 12c is improved to increase the output of the rotating electrical machine 100.

Moreover, a dimension G5 (see FIG. 14(a)), in the radial direction, of each bulge portion Qe is desirably set so as to satisfy the following dimensional relationships.

2G5≦G11 (9)

2G5≦G13 (10)

2G5≦G31 (11)

2G5≦G33 (12)

In this case as well, when G11, G31, G13, and G33 are set at the same distance X1, the above relationships (9) to (12) are put together as follows.

2G5≦X1 (13)

When such a dimensional relationship is satisfied, the bulge portions Qe which occur during bending do not come into contact with each other, so that an effect of improving the insulation property is achieved.

The description has been given with the insulating members 35, but the insulating members 35 may be omitted as necessary. In addition, it is conceivable that interference between the bulge portions Qe is avoided by crushing and flattening the bulge portions Qe in the radial direction R before or after bending. In this case, however, the man-hour may additionally increase, leading to an increase in the production cost, and also damage to an insulating film may increase, resulting in a decrease in the insulation property. In the present invention, the production is possible at low cost as compared to the case of crushing the bulge portions Qe, and an effect of reducing damage to the insulating film to improve the insulation property is achieved.

### Embodiment 2

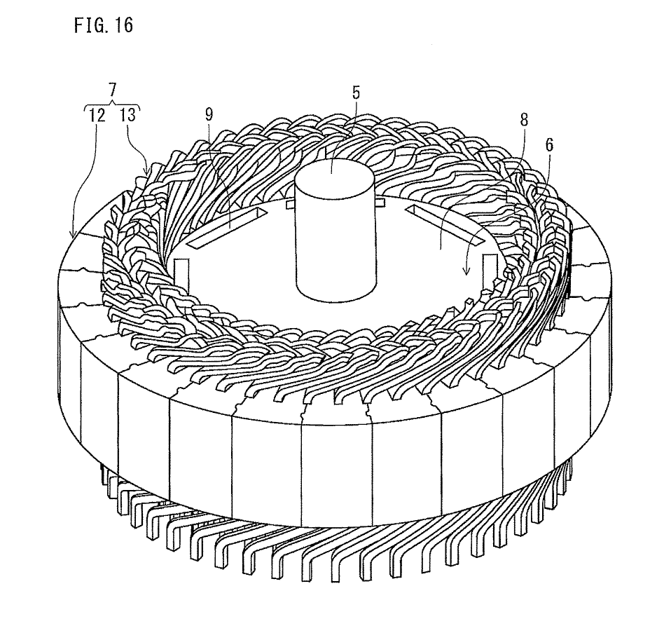

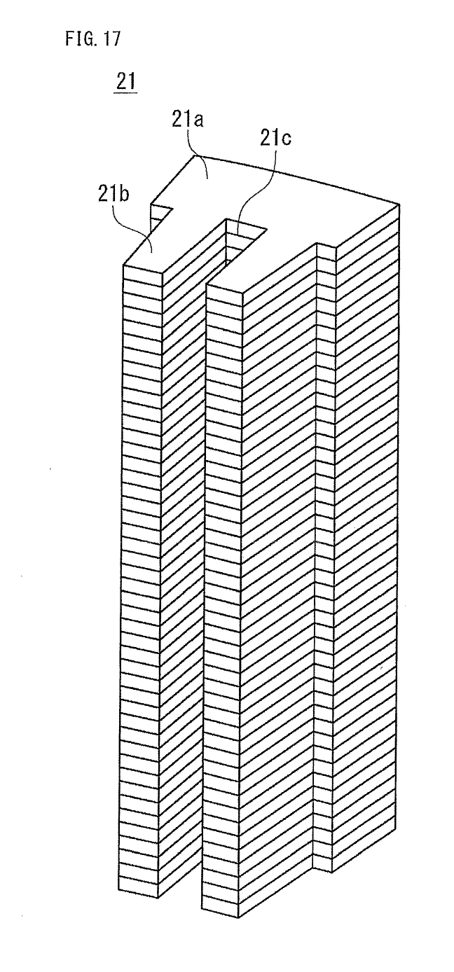

FIG. 16 is a perspective view showing an armature and a rotor in a rotating electrical machine according to Embodiment 2 of the present invention, FIG. 17 is a perspective view showing a core block of the armature in the rotating electrical machine, and parts corresponding to those in Embodiment 1 shown in FIGS. 1 to 5 are designated by the same reference characters.

Here, regarding Embodiment 2, only the differences in configuration from Embodiment 1 will be described.

The armature 7 includes an armature core 12 and an armature winding 13. Here, the armature core 12 includes a core block 21 shown in FIG. 17. The core block 21 is produced by stacking and integrating a predetermined number of electromagnetic steel sheets, and includes: a core back portion 21a which has a circular arc cross-sectional shape; two teeth 21b which are provided so as to extend inward in the radial direction from an inner peripheral wall surface of the core back portion 21a; and a slot 21c formed by the teeth 21b.

The armature core 12 is formed by sequentially arranging a plurality of (here, 24) core blocks 21 in the circumferential direction such that the teeth 21b are directed inward in the radial direction and the side surfaces, in the circumferential direction, of the core back portions 21a butt against each other, to dispose the core blocks 21 in an annular shape.

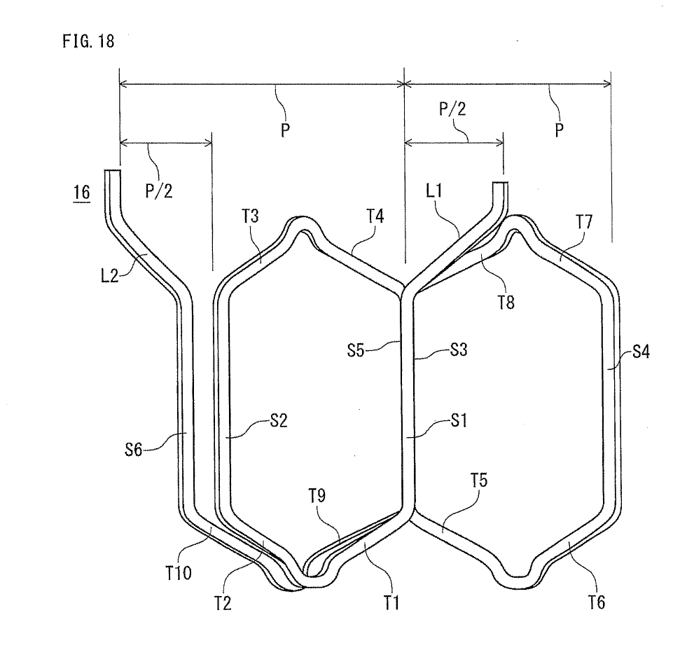

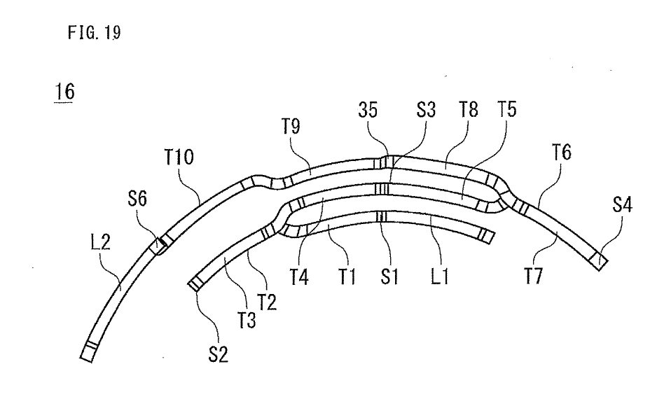

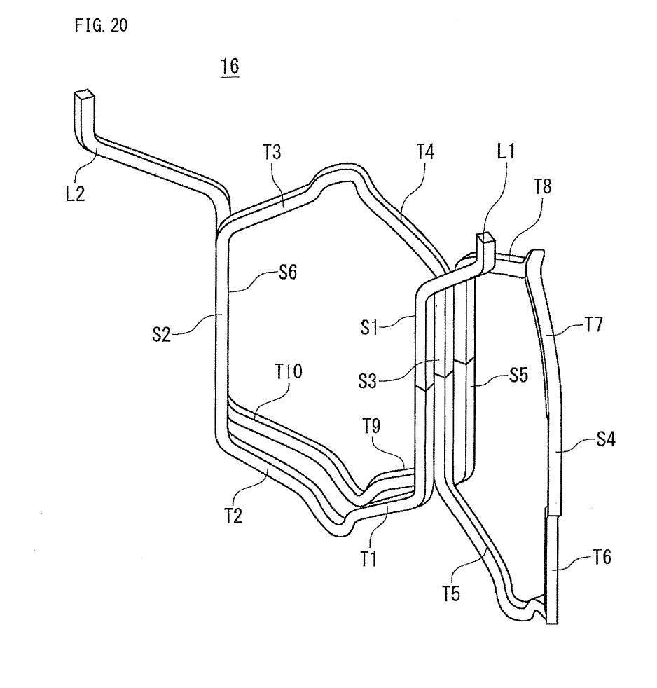

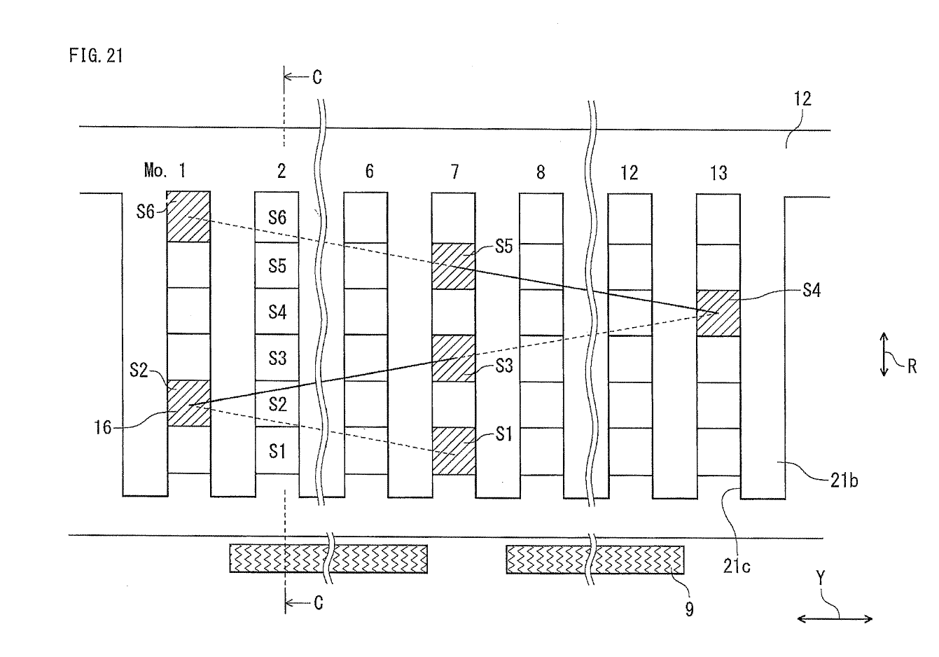

FIG. 18 is a front view showing a partial coil forming the armature winding of the armature used in the rotating electrical machine according to Embodiment 2 of the present invention, FIG. 19 is a plan view of the partial coil in FIG. 18, and FIG. 20 is a perspective view of the partial coil in FIG. 18. In addition, FIG. 21 is a cross-sectional schematic view of a winding state of partial coils with respect to the armature core of the rotating electrical machine according to Embodiment 2 of the present invention, as seen from the axial direction.

In Embodiment 2, the armature winding 13 is formed by having the partial coil 16 configured as shown in FIGS. 18 to 20 and arranging 48 partial coils 16 in the circumferential direction. Each partial coil 16 has a shape obtained by winding, in a 6 shape, a conductor wire having a rectangular cross-section and composed of, for example, a jointless continuous copper wire or aluminum wire that is coated with an enamel resin so as to be insulated.

That is, each partial coil 16 has: six slot-housed portions S1 to S6 which each have a straight rod shape and are housed in the slots 21c; turn portions T1 to T10 which integrally connect the slot-housed portions S1 to S6; and two leg portions L1 and L2 which individually project from the two slot-housed portions S1 and S6 and are bent along the circumferential direction in directions opposite to each other. Hereafter, the turn portions T1 to T10 and the leg portions L1 and L2 are collectively referred to as slot lead-out portion.

The two slot-housed portions S2 and S6 of the partial coil 16 are housed at positions overlapping each other in the circumferential direction Y, and the three slot-housed portions S1, S3, and S5 of the partial coil 16 are also housed at positions overlapping each other in the circumferential direction Y. The slot-housed portions S2 and S6 are separated from the slot-housed portions S1, S3, and S5 in the circumferential direction by the distance corresponding to six slots (=one magnetic pole pitch P). In addition, the slot-housed portions S1, S3, and S5 are separated from the slot-housed portion S4 in the circumferential direction by the distance corresponding to six slots (=one magnetic pole pitch P).

Moreover, a terminal end portion of the leg portion L1 is separated from the slot-housed portions S1, S3, and S5 by the distance corresponding to a half magnetic pole pitch (=P/2). Similarly, a terminal end portion of the other leg portion L2 is separated from the slot-housed portions S2 and S6 by the distance corresponding to the half magnetic pole pitch (=P/2).

Therefore, as shown in FIG. 21, for example, when consecutive numbers are individually assigned to the respective slots 21c, which are formed so as to be aligned in the circumferential direction Y, in order from left to right in the drawing, if the slot-housed portions S2 and S6 are housed in the first slot 21c, the slot-housed portions S1, S3, and S5 are housed in the seventh slot 21c which is separated from the first slot 21c by the distance corresponding to six slots, and the slot-housed portion S4 is housed in the thirteenth slot 21c which is further separated from the seventh slot 21c by the distance corresponding to six slots.

Therefore, when focusing on only the seventh slot 21c, if the slot-housed portions S1, S3, and S5 of the partial coil 16 shown in FIGS. 18 to 20 are housed in the seventh slot 21c, the slot-housed portion S4 of the partial coil 16 (not shown) adjacent to this partial coil 16 at one side in the circumferential direction so as to partially overlap this partial coil 16 in the radial direction is housed in the same seventh slot 21c. In addition, the slot-housed portions S2 and S6 of the partial coil 16 (not shown) adjacent to this partial coil 16 at the other side in the circumferential direction so as to partially overlap this partial coil 16 in the radial direction are housed in the same seventh slot 21c. Thus, the slot-housed portions S1 to S6 for six layers are housed in the seventh slot 12c from the three partial coils 16 aligned in the radial direction R. Similarly, also in each of the other slots 21c, the slot-housed portions S1 to S6 for six layers are housed from three partial coils 16. Accordingly, all of the respective partial coils of which the slot-housed portions S1 to S6 for six layers are housed together in one slot 21c belong to the same phase.

The armature winding 13 is formed by arranging the 48 partial coils 16 in the circumferential direction Y, bending the terminal end portions of the leg portions L1 and L2 in the circumferential direction Y, then joining the terminal end portions of the leg portions L1 and L2 by joining means such as welding, and further connecting a power feeding portion, a neutral point, or the like. Then, the armature 7 is obtained by inserting the slot 21c of each core block 21 with respect to the respective slot-housed portions S1 to S6 from the radial direction R.

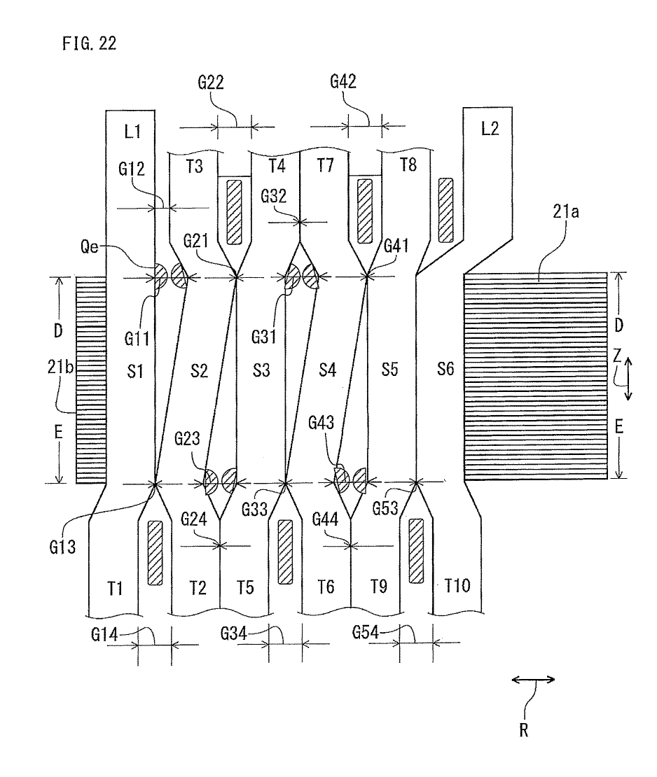

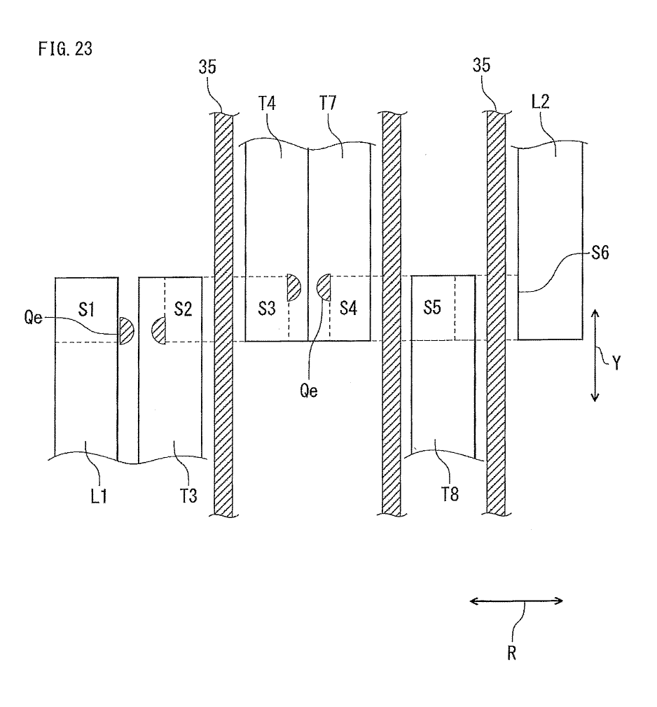

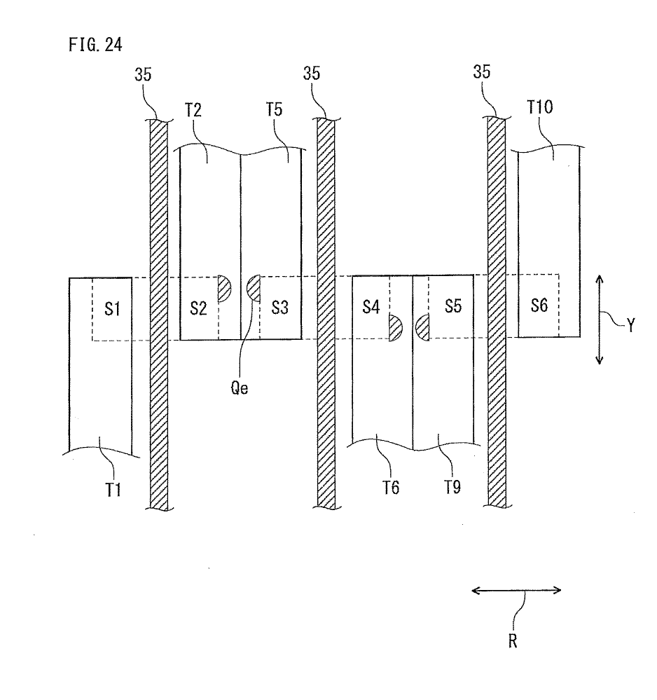

FIG. 22 is a cross-sectional schematic view taken along the line C-C in FIG. 21, FIG. 23 is a cross-sectional schematic view taken along the line D-D in FIG. 22, and FIG. 24 is a cross-sectional schematic view taken along the line E-E in FIG. 22. In FIG. 22, the right-left direction is the radial direction R, and the up-down direction is the axial direction Z. In addition, in FIGS. 23 and 24, the right-left direction is the radial direction R, and the up-down direction is the circumferential direction Y.

In the case where the slot-housed portions S1 to S6 for six layers are housed in one slot 21c, as shown in FIG. 22, the gaps between the upper ends of the respective slot-housed portions S1 to S5 at the leg portions L1 and L2 side are denoted by G11, G21, G31, and G41, respectively, and the intervals between the leg portions L1 and L2 projecting outside in the axial direction Z from the slot 21c and the turn portions T3, T4, T7, and T8 are denoted by G12, G22, G32, and G42, respectively. In addition, the gaps between the lower ends of the slot-housed portions S1 to S6 at the side opposite to the leg portions L1 and L2 side are denoted by G13, G23, G33, G43, and G53, respectively, and the gap between the turn portions T1, T2, T5, T6, T9, and T10 projecting outside in the axial direction Z from the slot 21c are denoted by G14, G24, G34, G44, and G54, respectively. In this case, the following dimensional relationships are preferably satisfied for avoiding interference between the bulge portions Qe.

G11≧G12 (14)

G13≦G14 (15)

G21≦G22 (16)

G23≧G24 (17)

G31≧G32 (18)

G33≦G34 (19)

G41≦G42 (20)

G43≧G44 (21)

G53≦G54 (22)

Similarly as in the case of Embodiment 1, in the case of forming the partial coils 16 by using molds, actually, the formation is performed more easily with G11≈G31≈G23≈G43, G32≈G24≈G44, G21≈G41≈G13≈G33≈G53, and G22≈G42≈G14≈G34≈G14, than when the above respective intervals are finely specified. Thus, when: G11, G31, G23, and G43 are set at the same distance X1; G12 is set at the distance X2; G21, G41, G13, G33, and G53 are set at the same distance X3; G22, G42, G14, G34, G14 are set at the same distance X4; and G32, G24, and G44 are set at the same distance X5, the above relationships (14) to (22) are put together as follows.

X1≧X2 (23)

X3≦X4 (24)

X1≧X5 (25)

In this case, since X2>X5, the relationships (23) and (24) are preferably satisfied at the same time for actually avoiding interference between the bulge portions Qe.

When such dimensional relationships are satisfied, the thickness, in the radial direction R, of coil end can be reduced, and thus an effect of reducing the size of coil end is achieved, similarly to the case of Embodiment 1. In addition, an effect is achieved that the space factor of the coil in each slot 21c is improved to increase the output of the rotating electrical machine.

Moreover, the dimension G5 in the radial direction of each bulge portion Qe is desirably set so as to satisfy the following dimensional relationships.

2G5≦G11 (26)

2G5≦G23 (27)

2G5≦G31 (28)

2G5≦G43 (29)

In this case as well, when G11, G23, G31, and G43 are set at the same distance X1, the above relationships (26) to (29) are put together as follows.

2G5≦X1 (30)

When such a dimensional relationship is satisfied, the bulge portions Qe which occur during bending do not come into contact with each other, so that an effect of improving the insulation property is achieved.

The description has been given with the insulating members 35, but the insulating members 35 may be omitted as necessary. In addition, in Embodiment 2, the description has been given on the assumption that the slot-housed portions S1 to S6 for six layers are housed in each slot 21c. However, the present invention is also applicable to the case of (2N+2) layers (N is an integer of 1 or higher).

The present invention is not limited only to the configurations of Embodiments 1 and 2 described above. Without deviating from the gist of the present invention, the above configurations may be modified or partially omitted.

1. A rotating electrical machine comprising an armature formed by an armature winding being mounted to an annular armature core, wherein
the armature winding has slot-housed portions housed in slots formed in the armature core, and slot lead-out portions projecting outside from the slots and connecting the slot-housed portions in a circumferential direction, and
when, at a plurality of the slot-housed portions housed in the same slot so as to be aligned in a radial direction and at the slot lead-out portions connected in the axial direction from the respective slot-housed portions,
a distance in the radial direction at an axial end portion of the armature core between the two slot-housed portions adjacent to each other and connected to the two slot lead-out portions which are bent along the circumferential direction in one direction is denoted by X1,
a distance in the radial direction between the two slot lead-out portions which are bent along the circumferential direction in the one direction is denoted by X2,
a distance in the radial direction at the axial end portion of the armature core between the two slot-housed portions adjacent to each other and connected to the two slot lead-out portion which are bent along the circumferential direction in directions opposite to each other is denoted by X3, and
a distance in the radial direction between the two slot lead-out portions which are bent along the circumferential direction in the directions opposite to each other is denoted by X4,
a relationship of X1 to X4 is set so as to satisfy
X1>X2 and X3<X4.

2. The rotating electrical machine according to claim 1, wherein at least one of the slot lead-out portions connecting the slot-housed portions is composed of a jointless continuous conductor.

3. The rotating electrical machine according to claim 1, wherein an annular insulating member having an axis which coincides with an axis of the armature is inserted in a gap in the radial direction between the two slot lead-out portions which are bent along the circumferential direction in the directions opposite to each other.

4. The rotating electrical machine according to claim 1, wherein a dimension, in the radial direction, of a bulge portion which is formed at the slot lead-out portion so as to bulge in the radial direction is set so as to be smaller than the X1.

5. The rotating electrical machine according to claim 1, wherein in a partial coil which is a minimum unit forming the armature winding,
three or more of the slot-housed portions are sequentially connected by the slot lead-out portions which are continuous and jointless.

6. The rotating electrical machine according to claim 1, wherein
a partial coil which is a minimum unit forming the armature winding has the four slot-housed portions,
when the respective slot-housed portions are defined by assigning first to fourth thereto in order from a radially inner side for positions at which the respective slot-housed portions are housed within the slots, the first slot-housed portion housed in one slot and the fourth slot-housed portion housed in another slot are connected by a jointless slot lead-out portion, and the second slot-housed portion housed in the same slot as the first slot-housed portion and the third slot-housed portion housed in the same slot as the fourth slot-housed portion are connected by a jointless slot lead-out portion, and
at the jointless slot lead-out portions side, the respective slot lead-out portions connected to the first slot-housed portion and the second slot-housed portion are bent in one direction, and the respective slot lead-out portions connected to the third slot-housed portion and the fourth slot-housed portion are bent in one direction which is opposite to that of the respective slot lead-out portions extending from the first slot-housed portion and the second slot-housed portion.

7. The rotating electrical machine according to claim 1, wherein
a partial coil which is a minimum unit forming the armature winding has the four slot-housed portions,
when the respective slot-housed portions are defined by assigning first to fourth thereto in order from a radially inner side for positions at which the respective slot-housed portions are housed within the slots, the first slot-housed portion housed in one slot and the fourth slot-housed portion housed in another slot are connected by a jointless slot lead-out portion, and the second slot-housed portion housed in the same slot as the first slot-housed portion and the third slot-housed portion housed in the same slot as the fourth slot-housed portion are connected by a jointless slot lead-out portion, and
at a side opposite to the jointless slot lead-out portions, the respective slot lead-out portions connected to the first slot-housed portion and the second slot-housed portion are bent in one direction, and the respective slot lead-out portions connected to the third slot-housed portion and the fourth slot-housed portion are bent in one direction which is opposite to that of the respective slot lead-out portions extending from the first slot-housed portion and the second slot-housed portion.

8. The rotating electrical machine according to claim 1, wherein
a partial coil which is a minimum unit forming the armature winding has the four slot-housed portions,
when the respective slot-housed portions are defined by assigning first to fourth thereto in order from a radially inner side for positions at which the respective slot-housed portions are housed within the slots, the first slot-housed portion housed in one slot and the fourth slot-housed portion housed in another slot are connected by a jointless slot lead-out portion, and the second slot-housed portion housed in the same slot as the first slot-housed portion and the third slot-housed portion housed in the same slot as the fourth slot-housed portion are connected by a jointless slot lead-out portion,
at the jointless slot lead-out portions side, the respective slot lead-out portions connected to the first slot-housed portion and the second slot-housed portion are bent in one direction, and the respective slot lead-out portions connected to the third slot-housed portion and the fourth slot-housed portion are bent in one direction which is opposite to that of the respective slot lead-out portions extending from the first slot-housed portion and the second slot-housed portion, and
at a side opposite to the jointless slot lead-out portions, the respective slot lead-out portions connected to the first slot-housed portion and the second slot-housed portion are bent in one direction, and the respective slot lead-out portions connected to the third slot-housed portion and the fourth slot-housed portion are bent in one direction which is opposite to that of the respective slot lead-out portions extending from the first slot-housed portion and the second slot-housed portion.
